(19) United States
(12) Patent Application Publication
(10) Pub. No.: US 2012/0118928 A1
(43) Pub. Date: May 17, 2012

(54) BICYCLE RACK FOR A VEHICLE

(76) Inventors: Macalister Laws, Bellingham, WA (US); Andy Christensen, Bellingham, WA (US)

(21) Appl. No.: 13/297,898

(22) Filed: Nov. 16, 2011

Related U.S. Application Data
(60) Provisional application No. 61/414,162, filed on Nov. 16, 2010.

(51) Int. Cl. B60R 9/00

(52) U.S. Cl. 224/403; 224/545; 224/519

(57) ABSTRACT

This disclosure relates to the field of bicycle racks configured in one form to retain a plurality of bicycles within a truck-style vehicle. In one form, the vehicle has an open bed and a tailgate with the tailgate in the lowered or open position. In another form, the vehicle has an open bed and the tailgate in the raised or closed position. In yet another form, a trailer hitch receiver is utilized to attach the bicycle rack to a vehicle.

### RELATED APPLICATIONS

This application claims priority benefit of U.S. Ser. No. 61/414,162, filed Nov. 16, 2010 incorporated herein by reference.

### BACKGROUND OF THE DISCLOSURE

### Field of the Disclosure

This disclosure relates to the field of bicycle racks configured in one form to retain a plurality of bicycles within a truck-style vehicle. In one form, the vehicle has an open bed and a tailgate with the tailgate in the lowered or open position. In another form, the vehicle has a closed bed and the tailgate in the raised or closed position. In yet another form, a trailer hitch receiver is utilized to attach the bicycle rack to a vehicle.

### SUMMARY OF THE DISCLOSURE

Disclosed herein is a bicycle rack to be attached to a vehicle, the bicycle rack in one form comprising several components. The first component being a base frame configured to be removably coupled to the vehicle as a unit. The second component being a forward support extending upward from the frame and pivotably coupled thereto. In one form, the forward support comprises a plurality of upright members. Another component being an upper cross member attached to and extending between the forward upright members, wherein the forward cross member supports the bicycle at the V formed at a down tube and front fork junction of the bicycle.

The bicycle rack as recited above may further comprise a compressible protective pad attached to the upper forward cross member so as to protect the bicycle from contacting the upper forward cross member.

In one embodiment, straps attach to the compressible protective pad at transverse locations to prohibit transverse movement of the bicycle relative to the compressible protective pad.

The bicycle rack may be configured to attach to a vehicle where the vehicle comprises a tailgate in an upward or closed position, and the compressible pad overlies and protects an exterior portion of the tailgate from contact with the frame of the bicycle. In another configuration, the vehicle comprises a tailgate in a lower or open position and the base frame of the bicycle rack is coupled to the tailgate and extends into a bed portion of the vehicle to substantially prohibit movement or rotation of the tailgate relative to a bed portion of the vehicle.

A different embodiment is disclosed wherein: the vehicle comprises a trailer hitch receiver. In this embodiment, the bicycle rack may comprise a lower horizontal bar coupled to the base frame; and the lower horizontal bar may be configured to be removably coupled to the trailer hitch receiver.

The bicycle rack as disclosed may further comprise an upwardly angled bar pivotably coupled to the lower horizontal bar so as to be selectively positioned thereto; and an upper horizontal bar pivotably coupled to the upwardly angled bar so as to be selectively positioned thereto; and the base frame is fixedly coupled to the upper horizontal bar.

The bicycle rack as disclosed may be assembled wherein the bicycle rack is arranged longitudinally relative to the vehicle. The bicycle rack may alternatively be assembled wherein the bicycle rack is arranged transversely relative to the vehicle.

The bicycle rack as disclosed may further comprise a rear extension portion pivotably coupled to the base frame and extending upwardly and rearwardly therefrom. In one form, the rear extension comprises a plurality of separator bars having a gap there between slightly larger than the width of a back wheel of the bicycle to be held in the bicycle rack. The bicycle rack may be assembled wherein the separator bars maintain transverse positioning of the back wheel of the bicycle relative to the frame.

Also disclosed is a protective pad for protecting a vehicle having a tailgate from direct contact with the frame of a bicycle. In one form the pad comprises: a conformable main body; a plurality of tailgate attachment straps configured to attach the protective pad to the tailgate of the vehicle; and, a plurality of bicycle attachment straps attached to the protective pad at transverse locations thereon to couple the pad to the bicycle. In this embodiment, the bicycle may contact the protective pad at the V formed at the down tube and front fork junction.

### BRIEF DESCRIPTION OF THE DRAWINGS

FIG. 1 is a side view of one embodiment of the disclosure attached to a pickup truck with the tailgate in a lowered position.

FIG. 2 is a side view of one embodiment of the disclosure attached to a pickup truck with the tailgate in a raised position.

FIG. 3 is a side view of one embodiment of the disclosure attached to a pickup truck with the tailgate in a raised position.

FIG. 4 is a side view of one embodiment of the disclosure attached to a trailer hitch receiver of a pickup truck with the tailgate in a raised position.

FIG. 5 is a top view of one embodiment of the disclosure with two bicycles attached thereto.

FIG. 6 is a side view of one embodiment of the disclosure without a vehicle nor bicycle shown.

FIG. 6A is a side view of the embodiment of FIG. 6 in a storage configuration.

FIG. 7 is a top view of the embodiment of FIG. 6.

FIG. 8 is a side view of three separated portions of one embodiment of the disclosure.

FIG. 9 is a top view of the base frame in one embodiment of the disclosure.

FIG. 10 is a plan view of one embodiment of the rear extension portion of the disclosure removed from the other components.

FIG. 11 is a plan view of one embodiment of the forward extension portion removed from the other components.

FIG. 12 is a side cutaway view of one embodiment of the disclosure as shown in FIG. 1, with the bicycles and pad removed to show the remaining portions.

FIG. 13 is a side cutaway view of one embodiment of the pad and straps attached thereto.

FIG. 14 is a side cutaway view of one embodiment of the disclosure showing how the straps may be used to attach the pad to the frame and the bicycle to the pad.

FIG. 15 is a cutaway detail view taken along line 15-15 of FIG. 14.

FIG. 16 is a side cutaway view of one embodiment of the disclosure utilizing a frame attached to a tailgate of a truck.

FIG. 17 is a side cutaway view of one embodiment of the disclosure utilizing a pad attached to a tailgate of a truck with no frame utilized

FIG. 18 is a side view of the embodiment of FIG. 4 in a partially collapsed orientation to reduce the vertical space required.

FIG. 19 is a side view of the embodiment of FIG. 18 in another stage of collapse.

FIG. 20 is a side view of the embodiment of FIG. 19 in another stage of collapse.

FIG. 21 is a top view of the embodiment of FIG. 4 where the bicycles will be attached in a longitudinal orientation.

FIG. 22 is a top view of the embodiment of FIG. 4 where the bicycles will be attached in a transverse orientation.

### DESCRIPTION OF THE PREFERRED EMBODIMENTS

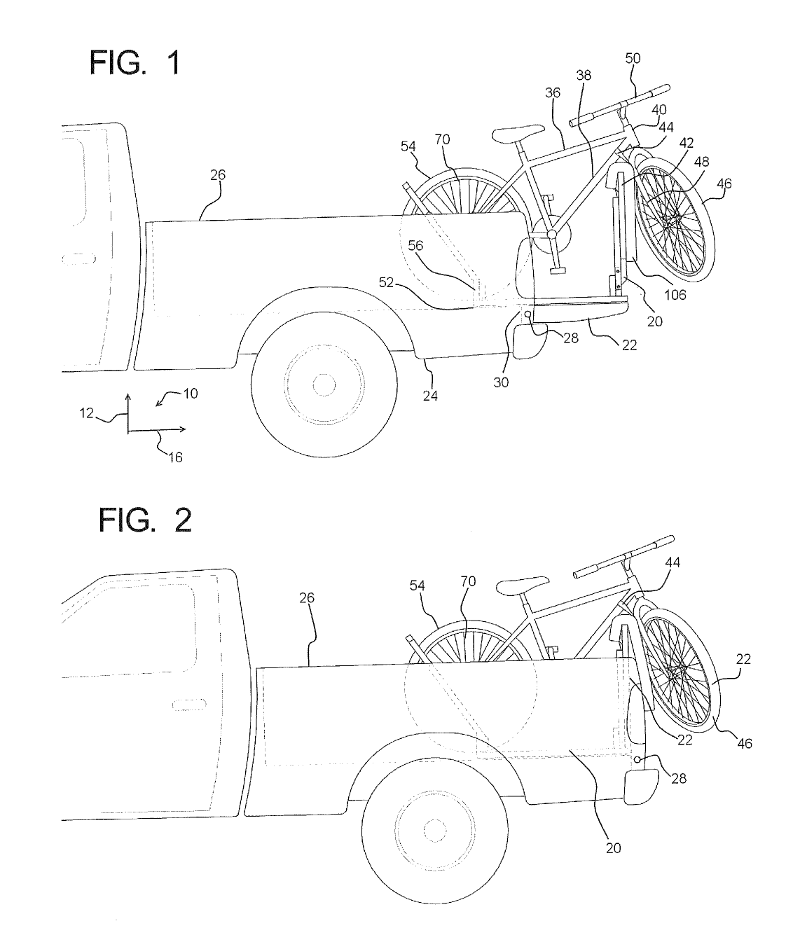

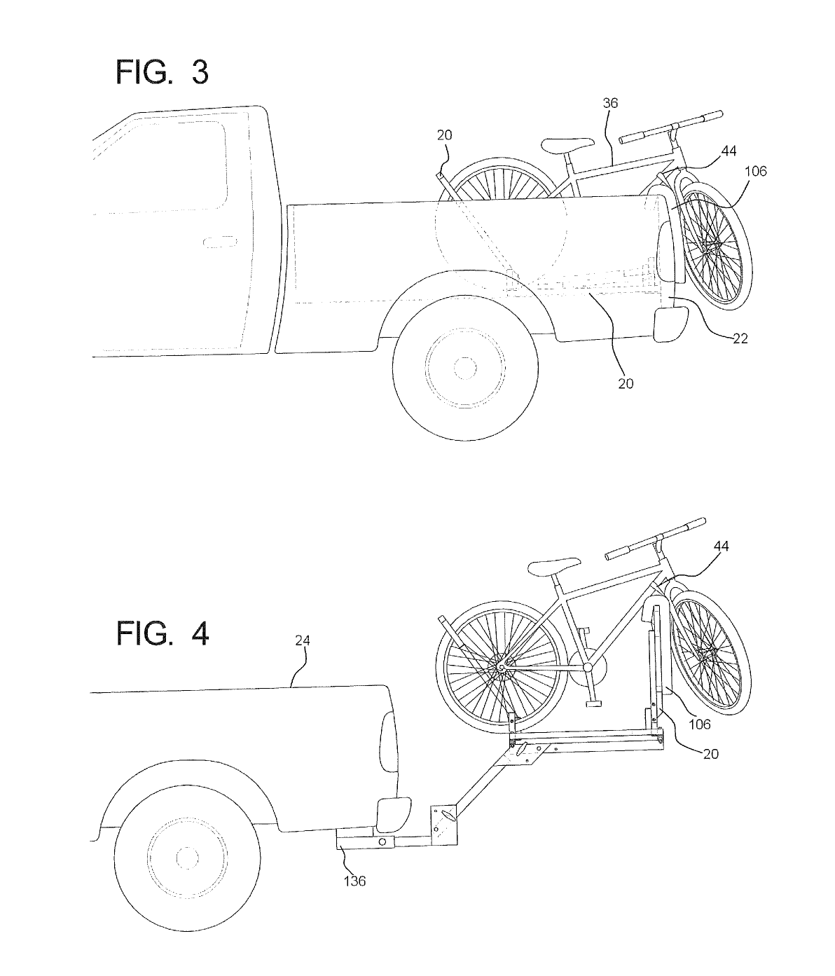

The bicycle carrying rack disclosed herein in several embodiments improves upon prior devices in that a bicycle can be conveniently, quickly, and securely placed upon and mounted to the rack without removing the wheels/tires. The rack is also easily modified. For example, the rack may be mounted to the back of a pickup truck with the tailgate down as shown in FIG. 1, or with the tailgate up as in FIG. 2. It is also conceived that the rack may be attached to the top (roof) or other portion of a vehicle. Additionally, the rack may be used where the bicycle does not engage the front portion of the rack at all, but rather engages the pad portion only as shown in FIG. 3. Additionally the rack may be used with components to attach to a trailer hitch receiver as shown in FIG. 4

Looking to FIG. 1, one embodiment of the bicycle rack 20 is shown mounted to the tailgate 22 of a pickup 24. The tailgate 22 is attached to the bed portion 26 of the pickup 24 by way of a hinge 28. Thus, there is a seam 30 between the tailgate 22 and the bed 26. When it is in its uppermost or closed position, the tailgate 22 will normally engage the sidewalls 32 of the pickup truck 24, as is well known in the art. In one form, the rack 20 is removably attached to the tailgate 22 by way of a plurality of straps 34.

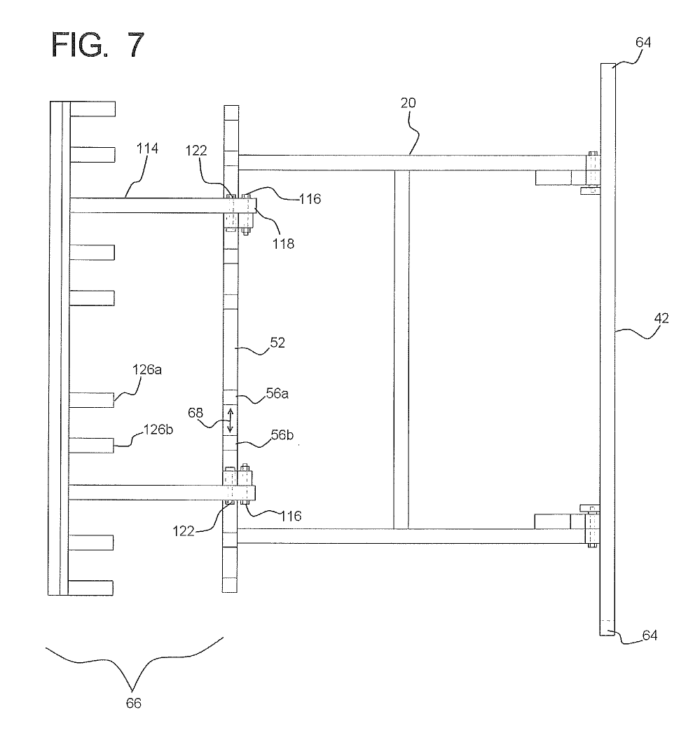

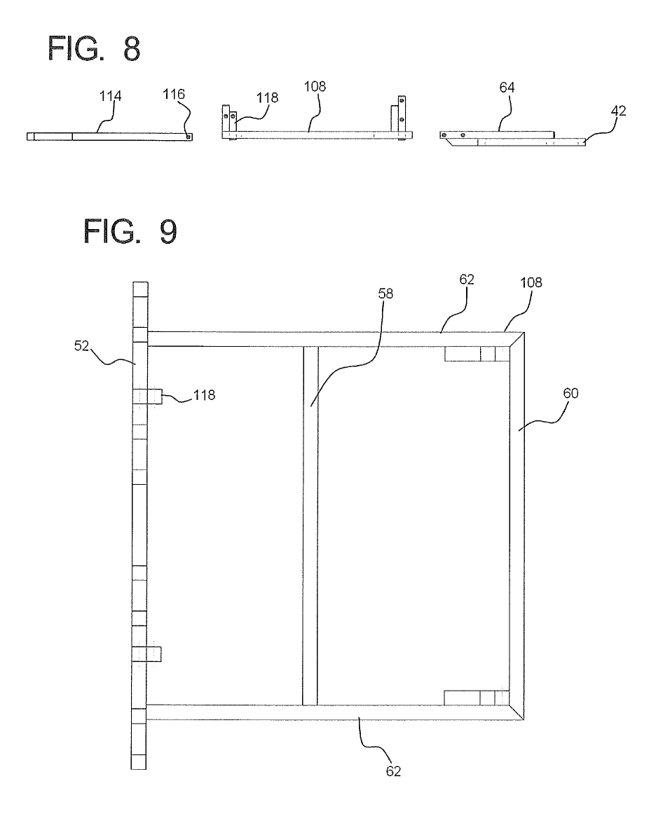

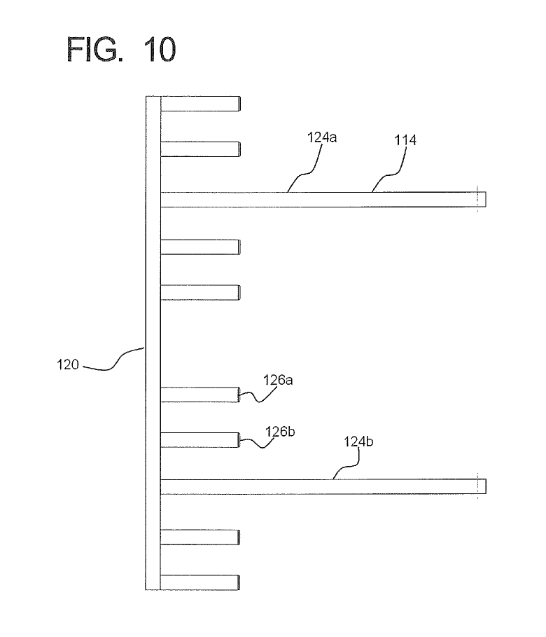

A numbering system will be utilized in this disclosure wherein a general description of a component will have a numeric identifier, and a particular element will have an alphabetic suffix. For example, the rear posts 56 of FIG. 1 are identified by the number 56, whereas particular posts of FIG. 7 are labeled 56a and 56b.

Looking to FIG. 2, it can be seen how the bicycle 36 is supported vertically and held in position by one embodiment of the rack 20. As shown, the V formed at the intersection of the down tube 38 and head tube 40 of the bicycle 36 rests upon an upper member 42 which may be covered by a compressible protective pad 106. Additionally, a plurality of straps 44 engage either the down tube 38 and/or head tube 40 to hold the bicycle from moving transversely along the axis of the upper member 42. These straps 44 prohibit the bicycle from repositioning sideways and engaging adjacent bicycles, or falling off of the rack and potentially out of the vehicle (pickup), the rack 20 below the upper cross member 42, the pickup, or other apparatuses that could damage the bicycle or be damaged by the bicycle 36. Additionally, prior to tightening of the straps 44, the front wheel/tire 46 is allowed to rotate about the axis of the head tube 40 so as to reduce the longitudinal extension of the front tire 46 and front forks 48 longitudinally rearward of the rack 20. Additionally, as the handlebars 50 of the bicycle are normally one of the widest parts, it may be desired to have the handlebars 50 rotated along with the front tire 46 to allow adjacent bicycles to be positioned closer together. A rear cross member 52 is provided at the rear of the rack 20, upon which rests the rear tire 54. A plurality of rear posts 56, substantially similar to the upper posts 44 and in longitudinal alignment therewith, may be provided to engage either side of the rear wheel/tire 54 to prohibit transverse movement of the rear portion of the bicycle relative to the rack 20.

To ease in understanding of the specific directions, an axis system 10 is shown in FIG. 1, and generally comprising a vertical axis 12, transverse axis 14, and longitudinal axis 16. These axes are intended to aid in understanding and are not intended to be read as limitations of the disclosure or claims.

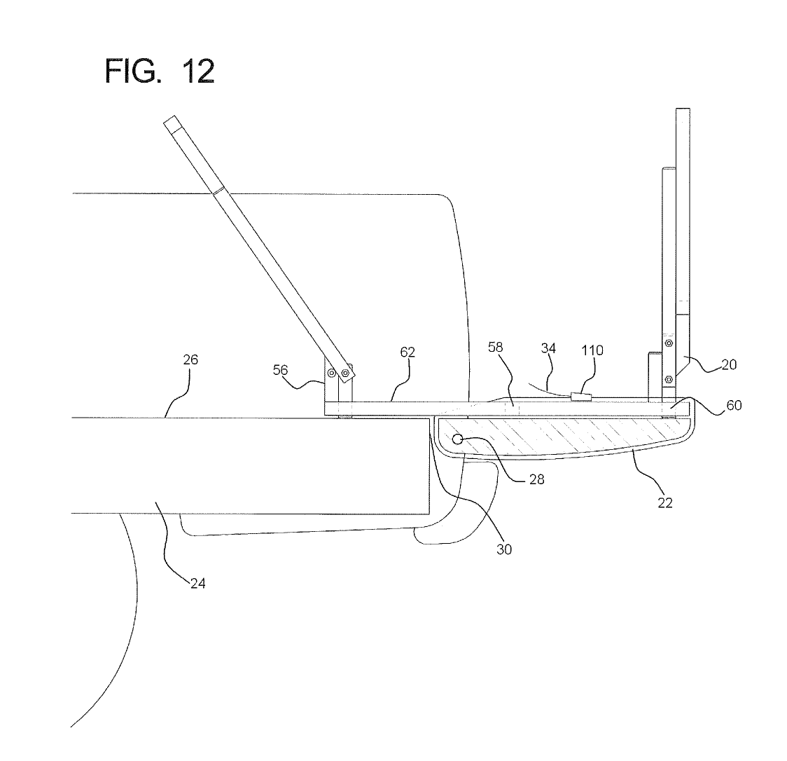

Also shown in the embodiment of FIG. 9, is the rack 20 comprises a base frame 108 which in turn comprises a middle cross member 58 and a forward cross member 60, which are connected to a plurality of longitudinal rails 62 along with the rear cross member 52. In one form, the cross members 52, 58, and 60 are welded, bolted, riveted, or otherwise affixed to the longitudinal rails 62. In one form, the base frame 108 is instead a unitary structure, such as a metal plate. In one form, the straps 34 (see FIG. 12) pass over the middle cross member 58 and forward cross member 60, pass under the tailgate 22 and are ratcheted or otherwise tensioned to securely hold the rack 20 in place upon the tailgate 22. A ratchet or buckle could be used for this purpose. Tests have shown that when the base frame 108 does not extend substantially into the fixed bed 26, the tailgate 22 may tend to rotate as the vehicle bounces or is otherwise jarred, such as in an off-road environment. Thus, in one form, as shown in FIG. 12, the longitudinal rails 62 extend longitudinally forward into the bed 26 of the pickup 24, well forward of the seam 30 and when properly secured to the tailgate 22, the longitudinal rails 62 resist rotation of the tailgate 22 about the hinge 28.

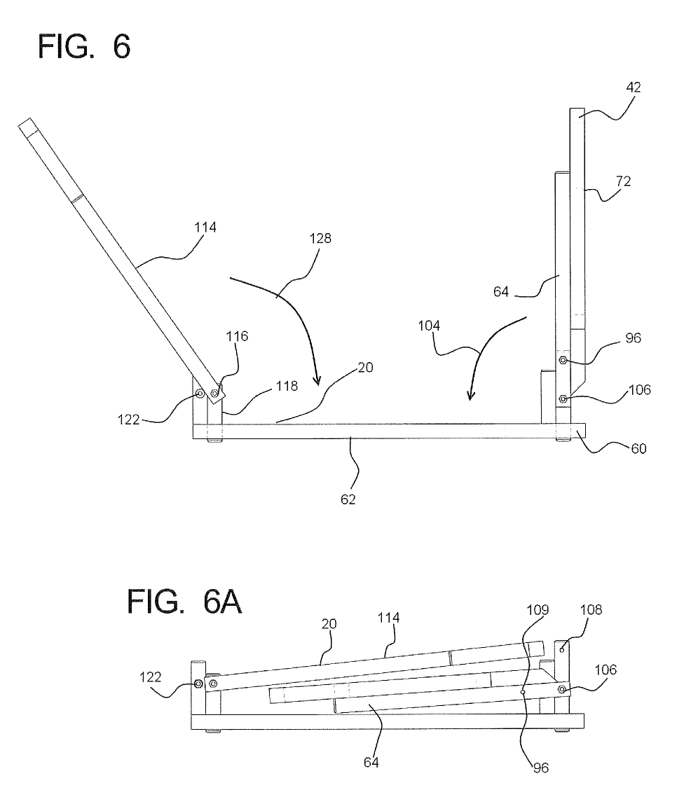

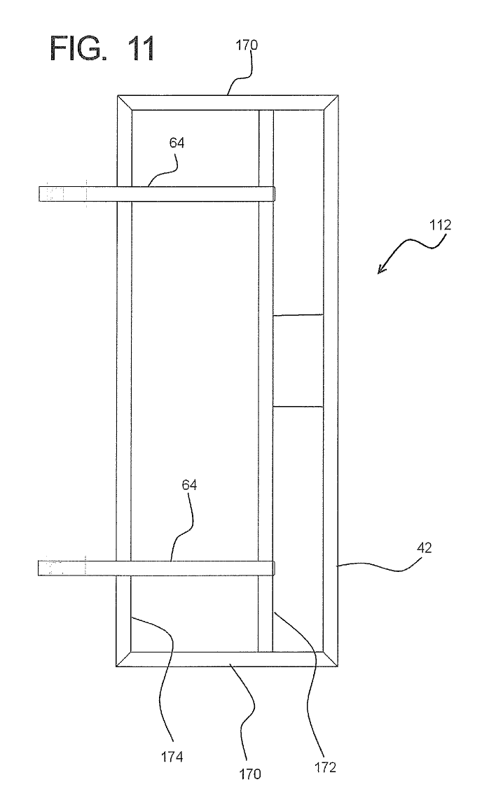

Looking to FIGS. 6 and 7, a top view of the rack 20 is shown with the bicycle 36 removed to more clearly show the components of the rack 20. These components include the parts already described and also show a plurality of vertical posts 64, more easily seen in FIG. 11, connecting the base frame 108 to a forward support 112 including the upper cross member 42. Also as shown, the rear separator assembly 66 is shown attached to the rear cross member 52 and the rear posts 56 extending substantially vertical therefrom. In one form, the rear posts comprise a series of paired posts 56a and 56b with a gap 68 therebetween. In one form, the gap 68 is slightly smaller than the width of a standard rear tire 54 and somewhat larger than the width of the rear wheel 70. As the rear tire 54 is generally compressible, forcing the rear tire into the gap 68 will tend to hold the rear portion of the bicycle 36 in place. As the rear wheel 70 is generally not compressible, it would obviously not be desired to have the gap 68 narrower than the rear wheel 70, although, it is conceived that the rear posts 56 in some embodiments may be partially deformed outward providing a spring clamp upon the rear tire 54 and/or rear wheel 70. In one form, a malleable or friction-inducing covering is provided on the rear posts 56, such as a polymer. Similarly, an upper separator assembly 72 is disclosed, generally comprising the upper cross member 42 and the straps 44

In one embodiment, the rear separator assembly 66 further includes a pivoting rear extension portion 114 as shown in FIG. 11, and as shown pivotably attached to the base frame in FIGS. 6 and 7. As shown, the rear extension portion 114 in one form is pivotably attached to the base frame by way of fasteners 116 through voids in upright posts 118 extending from the base frame, and aligned voids in the rear extension portion 114. To maintain the rear extension portion in the correct position, a plurality of pivot stops 122 may be utilized. The pivot stops hold the rear extension portion in position once it has been rotated from the collapsed position shown in FIG. 6A, to the extended position shown in 6 where arms 124 of the rear extension portion 114 contact the pivot stops 122. In one form, the pivot stops 122 are rod-like such as bolts, and may have a malleable surface thereupon to reduce vibration noise, and damage to the components.

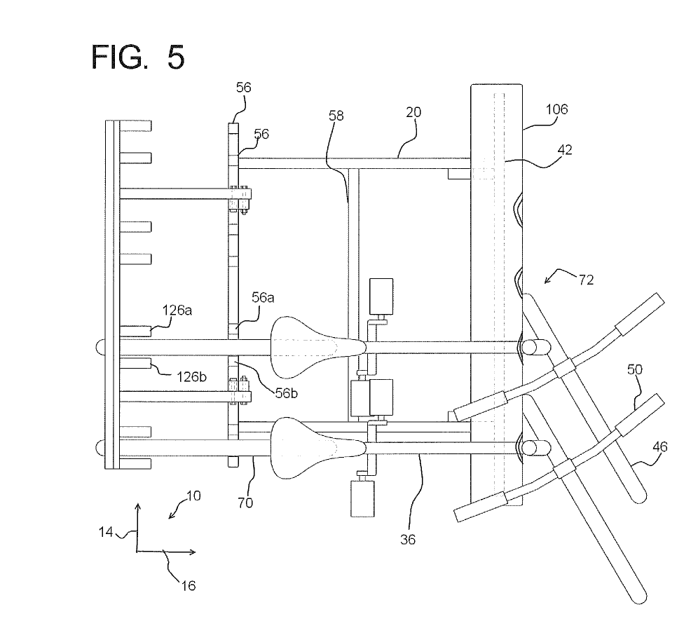

A rear transverse cross member 120 may be fixed to the rearward/uppermost portion of arms 124 of the rear extension portion 114. This rear transverse cross member 120 provides a stable attachment for rear tire separator bars 126 which fit on either transverse side of the rear tire 54 of the bicycle 36 in the same way as the rear posts 56 as defined above. As shown in FIG. 5, the rear tire separator bars 126a and 126b may be aligned with associated rear posts 56a and 56b respectively to hold the same rear tire of the bicycle.

In the embodiments described thus far, the rack 20 has been shown in an upright or assembled configuration. In FIG. 6A, the pins 96, which resist rotation of the vertical posts 64 relative to the longitudinal rails 62, have been released and the vertical posts 64 and the connected forward support assembly 72 have been rotated in direction 104 about pivot pins 106. In addition, the rear extension portion has been rotated about pivots 116 in direction of travel 128 to a collapsed position. This repositioning of the forward and rear upright portions significantly reduces the vertical dimension of the overall rack 20, whereupon it can be removed and/or stowed much easier. Alternatively, the apparatus can be folded to this orientation while still attached to the tailgate 22 of the pickup 24. When it is desired to utilize the rack 20 in one form, the rear extension member is rotated about the pivots 116 opposite the direction of travel 128 until contact is made with the pivot stops 122. Then the vertical posts 64 are rotated upward about the pivots 106to the orientation shown in FIG. 6, whereupon the pins 96 are re-inserted into the surfaces defining voids 108/109 of the frame and vertical posts 64 respectively.

In one embodiment of the disclosure, the upper cross member 42 is lower than the cross member shown. This orientation of a lower upper cross member reduces the vertical height of the handlebars above the bed of the vehicle when compared to the embodiments shown. By reducing the vertical height or the bicycle in the rack, it has been found possible to insert the bicycle into the rack when the rack is installed in a truck bed, even when a canopy or equivalent is present over the bed of the truck. In this embodiment, the rear wheels may extend vertically lower than the upper surface of the tailgate and/or bed of the vehicle. Additionally, by rotating the front wheel assembly, the longitudinal length of the bicycle is reduced, thus the bicycle will extend a much shorter distance rearwardly of the rack.

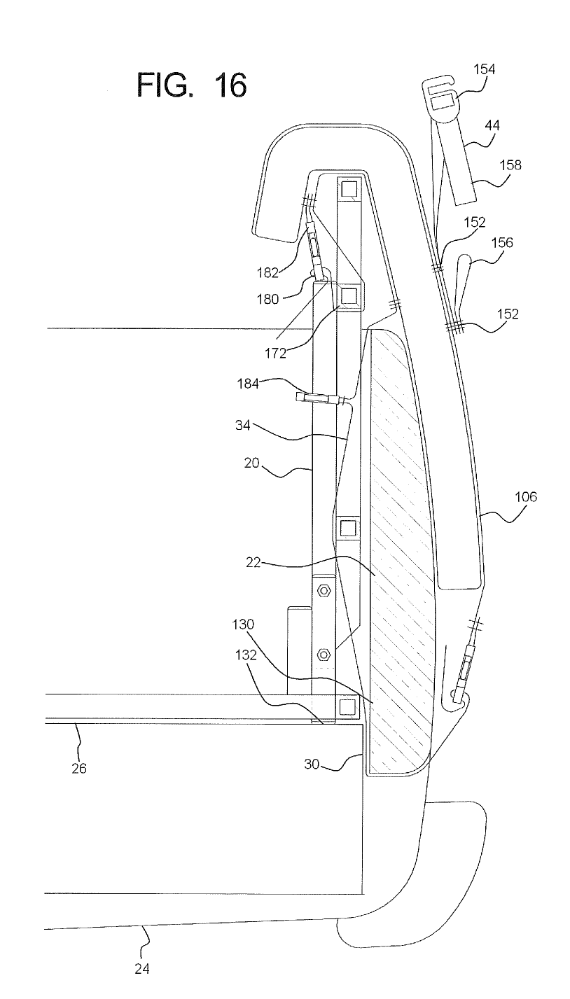

The rack is easily modified in form and function. For example, in FIG. 1, the rack 20 is strapped to the tailgate in a lowered position, so that a larger portion of the bed 26 is available for use in transporting other items. The method for such an attachment is shown in FIG. 12 and described above. Alternatively, FIG. 2 shows the rack 20 strapped to the tailgate in a raised position. In this arrangement, the bicycle extends significantly less beyond the back of the truck, but some of the storage space in the bed 26 is given up. This arrangement is more clearly shown in FIG. 16, where the strap 34 wraps around the tailgate 22, and around upright portions of the rack 20. In one form, the same strap is used to secure the pad 106 over the tailgate 22 and upright portions of the rack 20, both to protect the bicycle from the tailgate 22 and rack 20, but also to protect the tailgate 22 from damage resulting from contact with the bicycle 36. As it is usually less of a concern to protect the interior surface 130 of the tailgate 22, and bed 26 from damage, there may be little or no protection therebetween, although pads 132 may be provided.

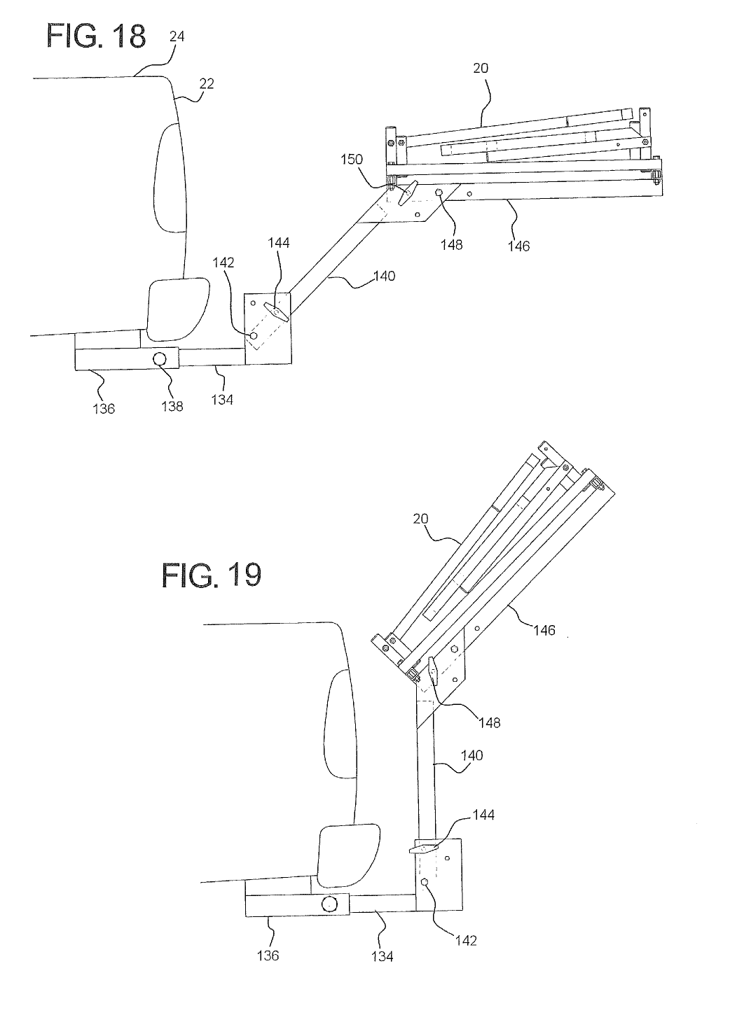

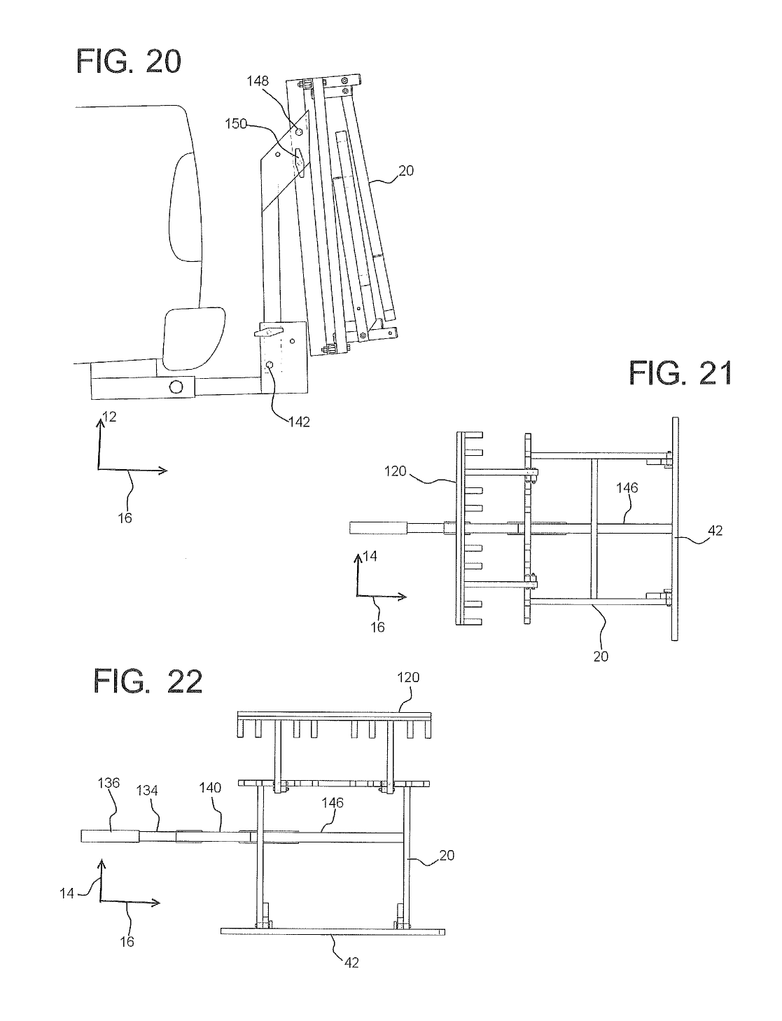

Looking to FIG. 4, it can be seen how the truck 24 has a trailer hitch receiver such as have become quite common not only to trucks, but to other vehicles capable of towing a trailer. Such receivers commonly come in box sizes where the inside measurement of the receiver is 1¼″, 2″, or 2½″. This embodiment comprises a lower horizontal bar 134 inserted into the hitch receiver 136 and held in place by way of a pin 138 or equivalent fastener. The lower horizontal bar 134 in one form is coupled to an upwardly angled bar to extend the rack 20 rearward of the tailgate. In one form the upwardly angled bar 140 is pivotably mounted to the lower horizontal bar 134 by way of a pivot 142, and maintained in position by way of a pin 144 in a lower position as shown in FIG. 18, or in a raised position as shown in FIG. 18. In one form, the upwardly angled bar 140 is attached to the frame 20 as previously described. In the embodiment shown, an upper horizontal bar 146 is pivotably coupled to the upwardly angled bar 140 at a pivot 148 and held in place by way of a pin 150 in a usable orientation as seen in FIGS. 18 and 19 or in a storage orientation as seen in FIG. 20 where the overall apparatus takes up significantly less space than that shown in FIG. 4. The frame 20 is then fixed by fasteners, welding, or other ways to the upper horizontal bar 146.

In another embodiment, not shown, the frame 20 is mounted directly to the horizontal bar 134 where the apparatus will be in a lower position than that shown in FIG. 4.

In the embodiments shown in FIGS. 4, and 18-21 the bicycles are arranged longitudinally, such that the rear tires are forward of the front tires relative to the orientation of the vehicle. These embodiments, as well as that shown in FIG. 1 could be arranged in reverse, with the front wheel of the bicycle forward of the rear wheel. This would be less feasible in the arrangement of FIG. 2 as the tailgate position may interfere with such an arrangement.

Another arrangement is provided in FIG. 22, where the rack is arranged along the transverse axis 14, so that the bicycles would be arranged with the front and rear wheels facing the left and right transverse sides of the vehicle, in either a left facing, or a right facing arrangement.

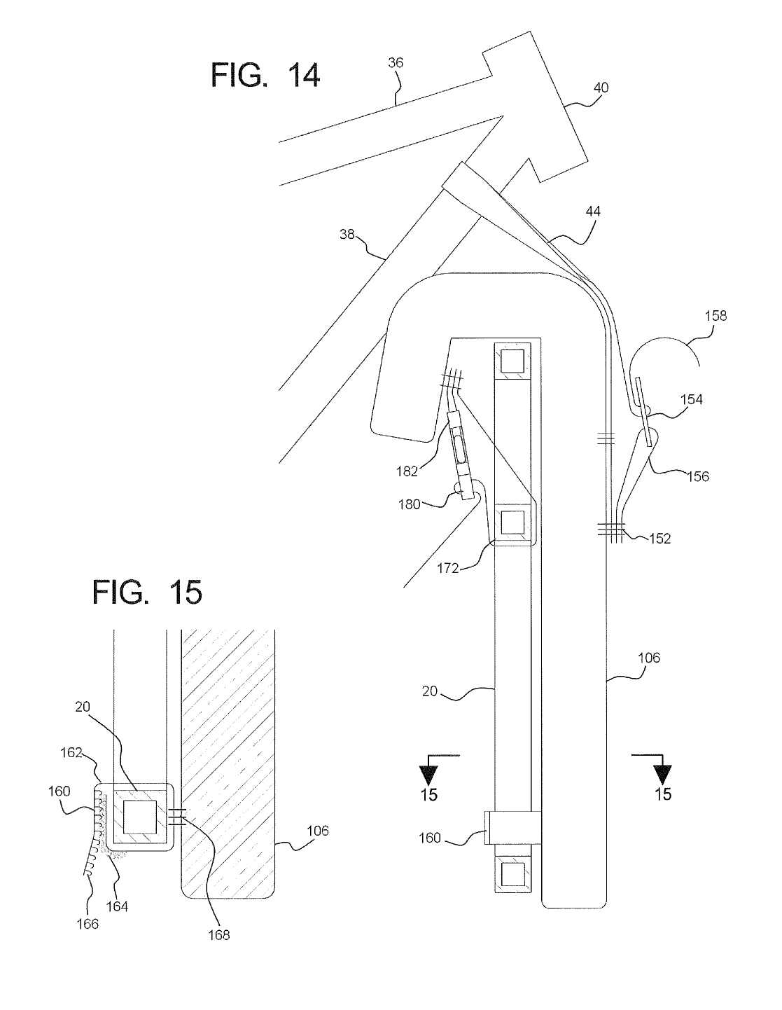

Looking to FIG. 14, the strap 44 can be seen attached to the downtube 38 of the bicycle 36. One form of this strap 44 is shown in FIG. 16 attached to the pad 106 by stitching to a covering thereof. This stitching 152 may also attach the strap to the pad 106. As shown, the strap 44 may have a hook style clip thereon which attaches to a loop 156 after being passed around a portion of the bicycle 36. At which point the free end 158 of the strap 44 may be tensioned to firmly secure the bicycle 36.

As shown in FIGS. 14 and 15 a hook and lop fastener 160 may be used to attach portions of the pad 106 to the frame. Such fasteners are well known and generally comprise a strap 162 having a loop portion 164 and a hook portion 166 which interoperate and can be used as shown to attach to the rack 20. In one form, the hook and loop fastener is stitched 168 to the pad 106 or may be otherwise affixed thereto.

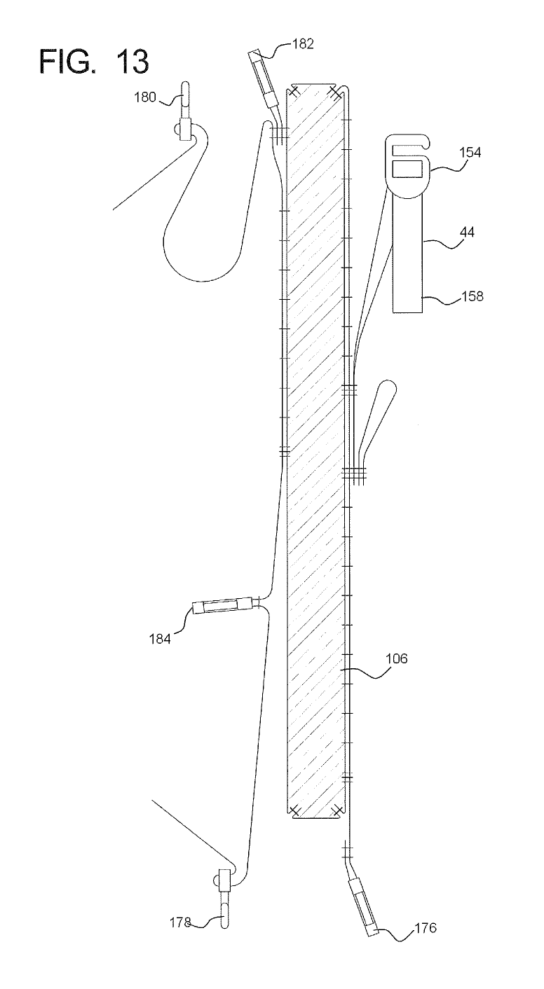

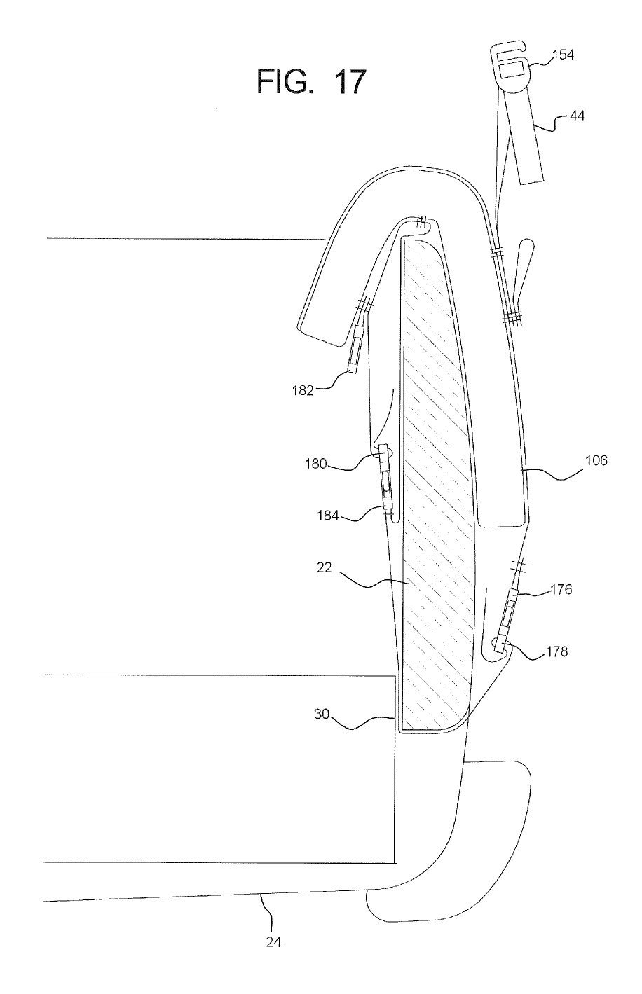

As further shown in FIGS. 13-16, quick release clips 176, 178, 180, 182 and 184 may be used to facilitate easy attachment and removal of the rack 20 to and from the vehicle. In the embodiment of FIG. 14, clips 180 and 182 are linked around the middle cross member 172, and the strap 160 holds the lower portion of the pad 106 in place. In the embodiment shown in FIG. 16, the same connections are made with clips 180 and 182, clip 184 is not used, and clips 176 and 178 are connected around the tailgate 22 to hold the pad 106 in place thereupon. In the embodiment of FIG. 17 the pad 106 is used without the rack 20. In this arrangement, clips 180 and 184 are coupled around the tailgate 22, and clips 176 and 178 are also coupled together. As shown, clip 182 is not used in this arrangement.

Looking to FIG. 11, one embodiment of the forward support 112 is shown comprising the vertical posts 64 and a plurality of cross members including a middle cross member 42 and lower cross member 174 attached thereto. The cross members 172 and 174 have a plurality of vertical interconnecting posts 170 attached thereto. In turn, the vertical interconnecting posts 170 support and are attached to the upper cross member 42 previously described.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A bicycle rack to be attached to a vehicle, the bicycle rack comprising:
a. a base frame configured to be removably coupled to the vehicle as a unit,
b. a forward support extending upward from the frame and pivotably coupled thereto;
c. the forward support comprising a plurality of upright members; and
d. an upper cross member attached to and extending between the forward upright members, wherein the forward cross member supports the bicycle at the V formed at a down tube and front fork junction of the bicycle.

2. The bicycle rack as recited in claim 1 further comprising a compressible protective pad attached to the upper forward cross member so as to protect the bicycle from contacting the upper forward cross member.

3. The bicycle rack as recited in claim 2 further comprising straps attached to the compressible protective pad at transverse locations to prohibit transverse movement of the bicycle relative to the compressible protective pad.

4. The bicycle rack as recited in claim 2 wherein the vehicle comprises a tailgate in an upward or closed position, and the compressible pad overlies and protects an exterior portion of the tailgate from contact with the frame of the bicycle.

5. The bicycle rack as recited in claim 1 wherein the vehicle comprises a tailgate in a lower or open position and the base frame of the bicycle rack is coupled to the tailgate and extends into a bed portion of the vehicle to substantially prohibit movement or rotation of the tailgate relative to a bed portion of the vehicle.

6. The bicycle rack as recited in claim 1 wherein:
a. the vehicle comprises a trailer hitch receiver, and
b. the bicycle rack comprises a lower horizontal bar coupled to the base frame; and
c. the lower horizontal bar is configured to be removably coupled to the trailer hitch receiver.

7. The bicycle rack as recited in claim 6 further comprising:
a. an upwardly angled bar pivotably coupled to the lower horizontal bar so as to be selectively positioned thereto;
b. an upper horizontal bar pivotably coupled to the upwardly angled bar so as to be selectively positioned thereto; and
c. the base frame is fixedly coupled to the upper horizontal bar.

8. The bicycle rack as recited in claim 6 wherein the bicycle rack is arranged longitudinally relative to the vehicle.

9. The bicycle rack as recited in claim 6 wherein the bicycle rack is arranged transversely relative to the vehicle.

10. The bicycle rack as recited in claim 1 further comprising:
a. a rear extension portion pivotably coupled to the base frame and extending upwardly and rearwardly therefrom;
b. the rear extension comprising a plurality of separator bars having a gap therebetween slightly larger than the width of a back wheel of the bicycle to be held in the bicycle rack; and
c. wherein the separator bars maintain transverse positioning of the back wheel of the bicycle relative to the frame.

11. A protective pad for protecting a vehicle having a tailgate from direct contact with the frame of a bicycle, the pad comprising:
a. a conformable main body;
b. a plurality of tailgate attachment straps configured to attach the protective pad to the tailgate of the vehicle;
c. a plurality of bicycle attachment straps attached to the protective pad at transverse locations thereon to couple the pad to the bicycle; and
d. wherein the bicycle contacts the protective pad at the V formed at the down tube and front fork junction.
